(19) United States
(12) Patent Application Publication
(10) Pub. No.: US 2012/0234802 A1
(43) Pub. Date: Sep. 20, 2012

(54) Machining Work Pieces with a Laser Apparatus and an Electric Arc Apparatus

(75) Inventors: Eberhard Wahl, Weilheim (DE); Arnd Szelagowski, Kirchheim unter Teck (DE); Uwe Stute, Neustadt am Ruebenberge (DE)

(73) Assignee: TRUMPF WERKZEUGMASCHINEN GMBH + CO. KG, Ditzingen (DE)

(21) Appl. No.: 13/419,598

(22) Filed: Mar. 14, 2012

Related U.S. Application Data
(63) Continuation of application No. PCT/EP2009/006634, filed on Sep. 14, 2009.

(51) Int. Cl. B23K 9/02; B23K 26/00

(52) U.S. Cl. 219/121.44; 219/121.85; 219/121.39; 219/121.6

(57) ABSTRACT

A technique for machining work pieces with a laser apparatus and an electric arc apparatus includes generating a plasma gas jet with the electric arc apparatus, generating a laser beam with the laser apparatus, generating an electric arc with the electric arc apparatus, guiding the electric arc through the laser beam to a machined spot inside or on a work piece, and cutting the work piece with the electric arc or the plasma gas jet.

### CROSS REFERENCE TO RELATED APPLICATION

This application is a continuation of and claims priority under 35 U.S.C. §120 to PCT Application No. PCT/EP2009/006634 filed on Sep. 14, 2009. The contents of this priority application are hereby incorporated by reference in their entirety.

### TECHNICAL FIELD

The invention relates to processes and devices for machining work pieces with a laser apparatus and an electric arc apparatus whereby a laser beam and an electric arc are guided onto a spot where the work piece is to be machined.

### BACKGROUND

A device for machining a work piece is disclosed in DE 201 01 452 U1; this device includes a laser apparatus and an electric arc apparatus. The electric arc apparatus focuses an electric arc onto the spot on the work piece to be machined. From a laser apparatus, a laser beam is directed at the foot of the electric arc by means of a focusing device so that the laser beam and the electric arc meet on the work piece. The electric arc is guided through the laser beam, whereby the laser beam is moved relative to the electric arc by means of its own controllable kinematics and thus guides the electric arc in the desired position and if necessary deflects it. The electric arc follows the foot point and/or focal point of the laser beam on the work piece. As a result the electric arc can be positioned and guided accurately onto the work piece. An oscillating welding movement can be achieved in this manner.

Due to the continuously increasing requirements for the machining of materials with respect to both the accuracy and the machining rate and/or the shortening of process time, it is necessary that such known technologies be developed further.

### SUMMARY

In general, this invention relates to machining work pieces with a laser apparatus and an electric arc apparatus such that the power density is increased in a plasma gas jet, thereby increasing the energy feed for machining work pieces.

One aspect of the invention achieves this by means of a process for machining work pieces, in which, in accordance with a first alternative, directly before the plasma gas jet meets the electric arc apparatus, the laser beam is moved towards the machining spot of the work piece from outside to the plasma gas jet and intersects the plasma gas jet. This makes it possible that a channel is created within the plasma gas jet through the laser beam causing a controlled increase of the conductivity of the plasma gas jet. Through this increase of conductivity, the increase of the electric arc current is also attained simultaneously, which results in an increase of energy introduced as a result of minor losses respectively of a reduced resistance for the electric arc current.

In accordance with a second alternative embodiment, a process for machining work pieces is provided in which at least one laser beam is fully aligned within the plasma gas jet, and thus, a channel is formed in the plasma gas jet for a controlled increase of the conductivity of the plasma gas jet. The electric arc is guided along this channel due to the increased conductivity and reduced resistance. In this manner, the electric arc can be focused and stabilized within the plasma gas jet. As such, the laser beam itself has no effect or only has insignificant effect in the process, i.e. the laser energy has no significant contribution in material machining, but only influences the plasma gas jet.

These processes facilitate material removal with an electric arc within laser-induced plasma. This removal can comprise both surface machining of various materials like metal, glass, ceramics or similar materials, as well as partitioning or cutting of such materials, particularly sheet metals. Likewise, welding of materials can be possible also. Through the stabilization and guidance of the electric arc within the channel created by the laser beam in the plasma gas jet, joining of various steels and aluminium can be made possible also. At the same time, little material destruction, and higher precision and rate of machining is made possible.

In some embodiments, an aligned laser beam is guided coaxially to the plasma jet within the plasma gas jet. With this, widening of the electric arc can be reduced and a high level of ionization of the plasma gas can be attained to increase the conductivity.

Furthermore, through the laser beam within the plasma gas jet, the concentration of the ionized gas is increased along the laser beam path. A plasma channel is ignited by means of the laser. Plasma is understood as a forth aggregate state in which the gas features an extremely high energetic state (ionization). It is therefore electrically conductive. Through these additional high energetic atoms the concentration and/or energy in the plasma gas jet increases.

The increase of conductivity is possible both due to the generation of plasma by the laser beam and by the generation of an excited state of the gas molecules (opto-galvanic effect), in which the additional energy for ionization is reduced.

Through the diameter of the laser beam, a diameter of the channel in the plasma gas jet is preferentially set for the constriction of an electric arc for machining work pieces. In this manner, various process parameters can be controlled so that, in dependence upon the tasks for machining, the diameter of the laser beam can be varied. The size and/or the diameter of the plasma channel formed by the laser determines the diameter of the plasma gas jet. By changing the plasma channel by means of variation of the laser beam as a result of raw beam changes, the plasma gas jet can be manipulated at will. Through this, the possibility occurs, depending upon the application (surface machining, cutting, welding, etc.), to set the most optimum process parameter. The width of the plasma channel determines the cutting joint width, and thus, the cutting rate. When welding, the required diameter of the working point for overlap can be set at will.

The laser beam is preferentially set with a focal point to an electrode of the electric arc apparatus, so that the focal point lies on the electrode or between the electrode and the machined spot on or inside the work piece. In this manner, the conductivity can be increased, and hence, the current flow of electric arc can be influenced and be concentrated within the plasma beam. At the same time, the material removal can be activated accordingly in dependence upon the machining process. Alternatively, it can also be provided that the focal point lies under the work piece to be machined.

In certain embodiments, the plasma gas jet is shielded by a gas. This can help reduce contamination with the surrounding. Moreover, a better shape of the plasma gas jet can be achieved.

An advantage of laser application is seen in the improved ignition capability during the start of the process. In particular, the process control can be improved by focused selection of the plasma and shielding gas with respect to absorption properties.

In certain embodiments, the plasma gas jet is fed perpendicularly to the machined spot of the work piece for particularly effective machining of work pieces. This maximizes the energy feed. At the same time, material removal from a cutting slot can be achieved. The plasma gas jet in the process supports the ablation of the material heated up by the electric arc.

In some embodiments, a plasma jet and a laser beam are fed coaxially to the machined spot of the work piece through an annular electrode. By this means, during the machining of the work piece, constant conditions for increasing the conductivity of the channel in plasma gas jet are set. Moreover, through such a coaxial arrangement, it is made possible that a gap between the annular electrode and the machined spot on the work piece can be expanded.

In some embodiments, the electric arc apparatus, the electric arc voltage, or the electric arc current can be regulated and monitored. This allows materials to be machined in a focused manner, for instance, welding or cutting as well as partial removal of material, particularly engraving or introduction of contours in a work piece. In today's welding sources, the connection between electric arc voltage and current-and-gap is already used as a control variable. Monitoring this variable can be used both for gap and power control. This provides the possibility of controlled machining under optimum conditions.

Another aspect of the invention provides a device for holding work pieces for a machining process on the work piece includes, in accordance with a first embodiment, at least a machining head through which a plasma gas jet is aligned from the electric arc apparatus towards the machined spot of the work piece and one or more laser beams of the laser apparatus are adjacent and cut the plasma gas jet directly from outside in front of the machined spot. Through this, a channel for increasing the conductivity of the plasma gas jet can be achieved within the plasma gas jet, through which focused guide of the electric arc is made possible. In certain embodiments, several laser beams are arranged adjacently from outside, directly in front of the machining spot, whereby the laser beams attain a constriction of the plasma gas jet and spreading is prevented.

In some implementations, the device includes a machining head in accordance with a further alternative embodiment, in which the laser beam of the laser apparatus is guided within the plasma gas jet so that the laser beam in the plasma gas jet forms a channel for increasing the conductivity of the plasma gas jet. In this way, the plasma cutting process can be improved again through the support of the laser beam. In addition, improved edge quality, narrow cutting joints, and an increased contour accuracy can be achieved.

In some implementations, the laser beam and an electrode of the electric arc apparatus are guided to the machined spot relative to one another in a fixed manner. This allows simple activation of the laser apparatus and electric arc apparatus with respect to the guide along a machined spot on or inside the work piece. In this way, it is ensured that the same circumstances always prevail with respect to the creation of the channel in the plasma gas jet through the laser beam.

In some examples, the machining head is moved by a one or several axes manipulator, and in particular, robots. This provides for flexible application readiness.

In certain examples, the machining head is moved like a scanner above the work piece to be machined. For this purpose, the machining head can be traversable preferably in X- and Y-direction along the work piece on a work piece holder and be disposed preferably movable in Z-direction or be disposed at least pivoted around one of the three spatial axes. Such an embodiment allows the machining head, for instance, in existing configurations of a laser flat-bed cutting machine to be used. Furthermore, such a machining head can be used also for further existing laser cutting machines that feature one- or multiple axes linear axis system. The connections provided for a laser beam and beam guide components can be used as usual.

Moreover, in some implementations, the electrode of the electric arc apparatus is formed as an annular electrode and a laser beam is disposed in a feasible manner within central opening of the electrode. This arrangement features a simple design. Furthermore, a quick and easy replacement of such annular electrodes, which are wear prone parts, can be provided for.

In certain embodiments, the machining head features a nozzle opening that serves for the formation of the plasma gas jet, and within this nozzle opening, an electrode of the electric arc apparatus is provided. Thus, it is preferably provided that the electrode is formed as annular electrode for central passage of the laser beam or that one or several laser beams is guided outside the nozzle opening. In some implementations, this machining head includes, coaxially to the nozzle opening for the plasma gas jet, a nozzle opening for issuing a shielding gas that surrounds the plasma gas jet and through which premature broadening of the plasma gas jet is prevented.

In some examples, the electrode of the electric arc apparatus adjoins a nozzle opening or lies within this nozzle opening, so that the plasma gas fully flows around the electrode and, in the flow direction, viewed from the plasma gas jet, the nozzle opening for shielding gas lies outside its nozzle opening after the discharge of the plasma gas. In this manner, full shielding of the plasma gas jet can be ensured.

In some implementations, one or more laser beams fed from outside to the plasma gas jet for creating the channel, feature an acute angle of less than 15°, preferably less than 10°, and in particular less than 5° between the plasma gas jet and the one or more laser beams with a common intersection in the machined spot or in front of the machined spot. In this way, broadening of the plasma gas jet can be counteracted. At the same time, a channel can be formed in the plasma gas jet prior to reaching the machined spot in order to increase the conductivity and to ensure the guidance of the electric arc.

The invention as well as further advantageous embodiments and modifications of the same are described in detail and explained in the following passage on the basis of the examples depicted in the drawings. The features to be derived from the description and drawings can be applied individually or in arbitrary combinations in accordance with the invention.

### DESCRIPTION OF DRAWINGS

FIG. 1 is a schematic view of a device for machining work pieces;

FIG. 2 is a schematic side view of a first embodiment of a machining head of the device in accordance with FIG. 1;

FIG. 3 is a schematic sectional view of an alternative embodiment to FIG. 2; and

FIG. 4 is a further schematic sectional view of an alternative arrangement of a laser apparatus and electric arc apparatus for the formation of the machining head.

Like reference symbols in the various drawings indicate like elements.

### DETAILED DESCRIPTION

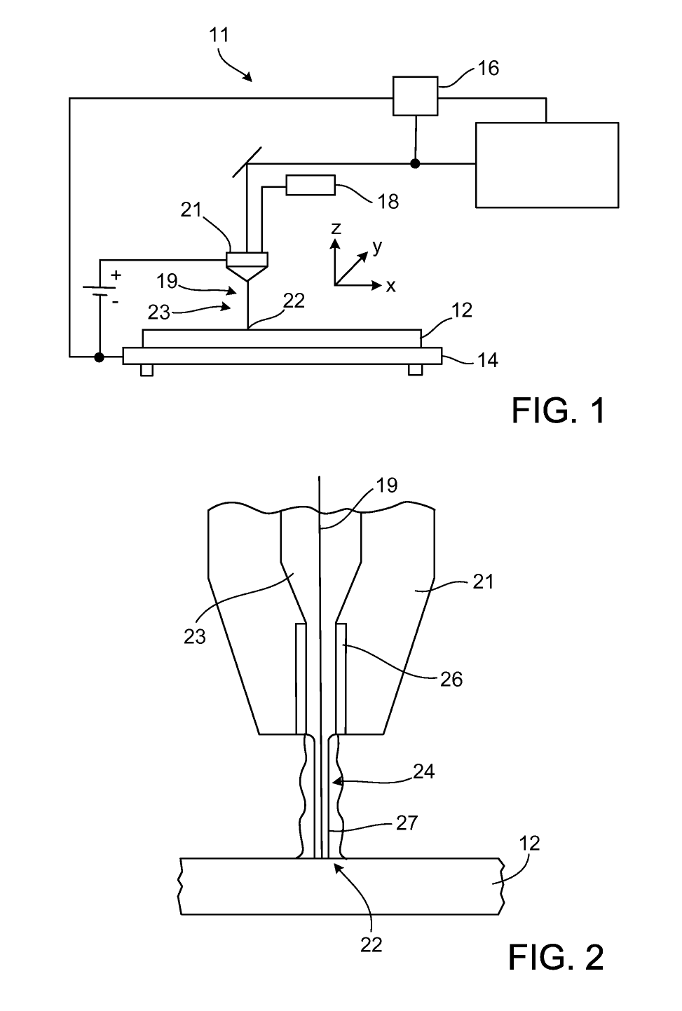

FIG. 1 illustrates a device 11 for receiving a plate-shaped work piece 12 on a work piece mount 14. Plate- or slab-shaped work pieces 12 are placed on this work piece mount 14 prior to machining by means of the device 11. The device 11 includes a control system 16, which is provided for the activation of a laser apparatus 17 and an electric arc apparatus 18. By means of the laser apparatus 17, a laser beam 19 is generated. The laser beam 19 is fed to a machining head 21 via a beam guidance system that is not depicted in detail, and from there, it is directed towards a machined spot 22 on or inside the work piece 12. By means of the electric arc apparatus 18, a plasma gas jet 23 is generated and is likewise fed via the machining head 21 to the machined spot 22. Within the plasma gas jet 23, an electric arc 24 is guided to the machined spot 22.

In some implementations, the machining head 21 is at least movable, by means of a linear axes system of a manipulating device, in the X- and Y-direction above the work piece 12 laid on the work piece mount 14. Furthermore, in some cases, the machining head 21 is movable in the Z-direction and/or can be pivoted about at least one of the three spatial axes. In some examples, multi-axial linear systems or manipulating devices like robots, for instance, are used. In other examples, the machining head is stationary or is only movable in the Z-axis and the work piece mount 14 is movable in the X- and Y-direction for the machining process.

Through the use of the device 11 with a laser apparatus 17 and an electric arc apparatus 18, machining of the work piece with laser-induced plasma and/or with an electric arc 24 guided in a channel of the plasma gas jet 23 formed by the laser beam 19 is possible. For this purpose, the work piece 12 is preferably configured as a negative electrode and the machining head as a positive electrode. This can also be reversed depending upon the specific application. The laser apparatus 17 can utilize a CO2-laser or UV-laser, for example. Also, short-pulse lasers as well as a laser with long pulse duration prove advantageous. Likewise applicable are diode lasers or fiber and/or disc lasers.

In the following FIGS. 2 to 4, individual embodiments or arrangements for setup and formation of a machining head 21 are described in detail.

In FIG. 2, a schematic sectional view of the machining head 21 is depicted. A laser beam 19 leads centrally through the machining head 21 and is guided towards the machined spot 22. The plasma gas jet 23 is guided coaxially to the laser beam 19. In some implementations, the laser beam 19 and the plasma gas jet 23 are guided through an electrode 26, for example, an annular electrode 26. Through the coaxial arrangement of the laser beam 19 within the plasma gas jet 23, a channel 27 is formed within which the ionized plasma gas features an increased conductivity in order to guide an electric arc 24 to the machined spot 22.

The plasma gas flow is constricted and formed by the annular electrode 26. Coaxially guiding the laser beam 19 through the plasma gas flow provides a foot point and/or a target point of the plasma gas jet 23 on the machined spot 22. With such an embodiment, for instance, a shielding gas can be dispensed with so that a simplified embodiment of the machining head is made possible.

In some implementations, the plasma gas jet 23 fed to the machining head 21 consists of single-atomic argon and/or double-atomic gases like hydrogen, nitrogen or oxygen that are ionized. Also, ionized air can be used as the plasma gas jet. Furthermore, the processing technique can be improved by selecting a specific shielding gas based on its absorption properties.

In certain examples, the annular electrode 26 and/or its longitudinal axis to the exit opening is/are perpendicular to the work piece 12 and/or to its projection plane in X- and Y-direction. The annular electrode 26 is thereby disposed as a replaceable annular electrode on the machining head 21 and, in some implementations, features a nozzle-shaped exit opening.

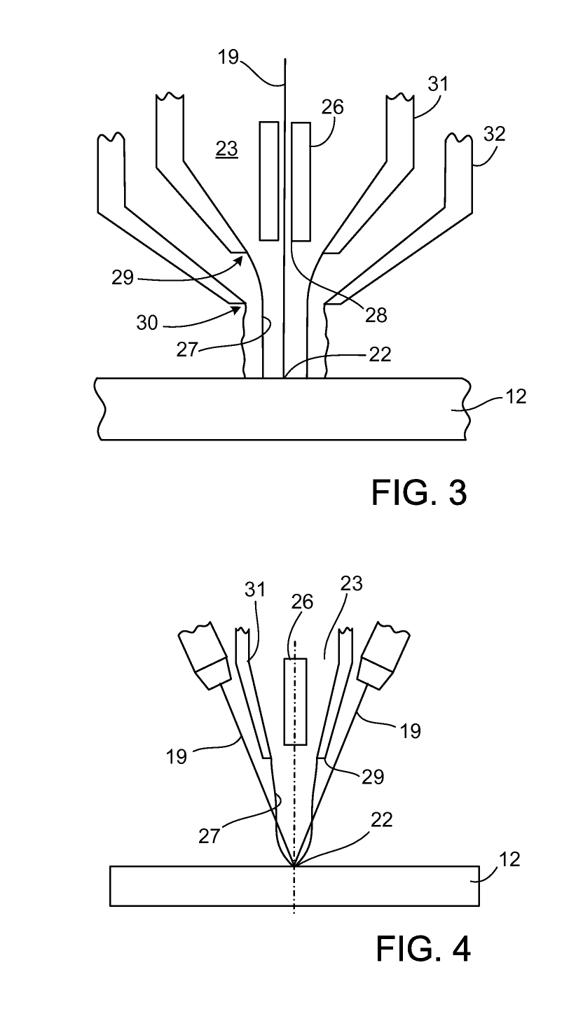

FIG. 3 illustrates an alternative embodiment of the machining head 21. An annular electrode 26 lies with its opening 28 within a nozzle opening 29 of a plasma gas nozzle 31, which lies within a nozzle opening 30 of a shielding nozzle 32. The laser beam 19 is guided coaxially through the annular electrode 26 and aligned towards the machined spot 22. The plasma gas nozzle 31 constricts the supplied plasma gas for the formation of the plasma gas jet through the nozzle opening 29. Subsequently, the plasma gas jet 23 is surrounded by the shielding gas by means of the shielding gas nozzle 32. This embodiment features advantages similar to those of the arrangement shown in FIG. 2. The plasma gas jet is fed additionally within the shielding jet. In this manner, the plasma gas jet 23 can remain bundled together. The laser beam 19 can further focus the channel 27, through which the electric arc 24 is likewise focused on the machined spot 22.

In FIG. 4, an alternative embodiment of the machining head 21 is depicted schematically in a section based on FIGS. 2 and 3. In this arrangement, the electrode 26 is formed as a rod or pin and is disposed within the plasma gas nozzle 31, whereby the plasma gas jet is first shaped by the plasma gas nozzle 31 and exits in the direction towards the machined spot 22. One or more laser beams 19 are aligned in the direction towards the machined spot 22 outside the plasma gas nozzle 31. In certain implementations, the laser beams 19 cut the plasma gas jet 23 on or prior to reaching the machined spot, so that channel 22 is formed for increasing the conductivity of the plasma gas in order to deflect and guide the electric arc 29. In particular implementations, the laser beams 19 are fed inclined at an angle less than 15° to the vertical feed axis of the plasma gas jet. In some arrangements, an angle less than 10° is provided and, in some cases, less than 5°. In this manner, a greater overlap section can be achieved in front of the machined spot 22 between the laser beams 19 and the plasma gas jet 23.

For the machining of the work piece 12, and particularly for partitioning the work piece 12, some implementations are configured such that a so-called pilot arc is first ignited for the beginning of such partition or cutting process. The pilot arc is ignited by means of high voltage between the plasma gas nozzle 31 and an electrode 26. This pilot arc leads to ionization between the plasma gas nozzle 31 and the work piece 12, whereby ignition of the electric arc 24 is initiated and the pilot arc is switched off. Therefore the plasma gas jet 23 burns between the electrode 26 and the work piece 12. In the plasma gas jet 23, a discharge section is defined by the channel 27 created by the laser beam 19, through which the electric arc 26 is guided and material ablation can be attained. Moreover, through this material machining, in particular material removal, an exact edge contour can be attained. Through the plasma gas jet 23 guided to the cutting gap, the removed material can be drained away in a proper manner. Suction can be effective here as an additional support.

During the machining of the work piece 12 it is preferably provided that the chronological correspondence of the laser beam 19 and a maximum voltage of the electrodes 26 be optimized and activated together. In some implementations, this is done by means of a common basis signal, which is used identically both for boosting the process energy for a laser apparatus 17 as well as for the amplification of the process energy for the electrode 26. Based on the machining tasks, the location of the focal point of the laser beam 19 is configured to lie directly below the electrode 26, so that only minor broadening of the laser beam 19 and of the channel 27 occurs in the plasma gas jet 23. Likewise, the focal point can lie between the electrode and the work piece 12, but also below the work piece 12. Moreover, it is sufficiently known with plasma cutting that the ignition process of the plasma gas jet upon penetration causes enormous wearing of the electrode, the nozzles, and the nozzle cap. Through the plasma channel that is attained by means of the laser, a high energy level is present in the gas so that for the ignition process less energy is needed, which in effect preserves the electrode and hence reduced wearing can be attained.

A number of embodiments of the invention have been described. Nevertheless, it will be understood that various modifications may be made without departing from the spirit and scope of the invention.

What is claimed is:

1. A method for machining work pieces with a laser apparatus and an electric arc apparatus, the method comprising:
generating a plasma gas jet with the electric arc apparatus;
generating a laser beam with the laser apparatus;
generating an electric arc with the electric arc apparatus;
guiding the electric arc through the laser beam to a machined spot inside or on a work piece; and
cutting the work piece with the electric arc or the plasma gas jet.

2. The method of claim 1, further comprising guiding the laser beam to intersect the plasma gas jet before the plasma gas jet reaches the work piece and controllably increasing a conductivity of the plasma gas jet by forming a laser-induced plasma channel.

3. The method of claim 1, wherein the laser beam is fully aligned within the plasma gas jet, the method further comprising controllably increasing a conductivity of the plasma gas jet by forming a laser-induced plasma channel.

4. The method of claim 1, wherein the laser beam is coaxially aligned within the plasma gas jet.

5. The method of claim 1, further comprising increasing, with the laser beam, a concentration of ionized gas within the plasma gas jet along a path of the laser beam.

6. The method of claim 1, further comprising constricting the electric arc by setting a diameter of the laser beam or the plasma channel inside the plasma gas jet.

7. The method of claim 1, wherein generating the laser beam comprises generating a laser beam having a focal point on a surface of an electrode of the electric arc apparatus or between the electrode and the machined spot.

8. The method of claim 1, further comprising surrounding the plasma gas jet with a shielding gas.

9. The method of claim 1, further comprising feeding the plasma gas jet perpendicularly onto the work piece.

10. The method of claim 1, further comprising feeding the plasma gas jet and the laser beam coaxially through an annular electrode of the electric arc apparatus onto the work piece.

11. The method of claim 1, feeding the laser beam through an opening of an annular electrode of the electric arc apparatus.

12. The method of claim 1, further comprising monitoring and regulating electric arc voltage, electric arc current, or both.

13. The method of claim 1, further comprising igniting the plasma gas jet or starting the electric arc using the laser beam as an ignition aid.

14. A machining device comprising:
a laser apparatus configured to generate a laser beam;
an electric arc apparatus configured to generate a plasma gas jet; and
a machining head through which the plasma gas jet is aligned from the electric arc apparatus to a machining spot of a work piece;
wherein the machining device is configured to controllably increase a conductivity of the plasma gas jet by forming a laser-induced plasma channel in the plasma gas jet; and
wherein the machining device is configured to guide the laser beam to intersect the plasma gas jet from outside the plasma gas jet or to guide the laser beam within the plasma gas jet.

15. The device of claim 14, wherein, in the machining head, the laser beam and an electrode of the electric arc apparatus are stationary relative to one another.

16. The device of claim 14, wherein the machining head is movable by means of a single- or multi-axial manipulator.

17. The device of claim 14, wherein the machining head is movable in an x- and a y-direction along the work piece and is movable in a z-direction or is pivotally mounted about at least one of three spatial axes.

18. The device of claim 14, wherein the electric arc apparatus comprises an annular electrode, and wherein the laser beam is configured to pass within a central opening of the annular electrode.

19. The device of claim 18, wherein the machining head includes:
a plasma gas nozzle next to the annular electrode; and
a shielding nozzle configured to provide a shielding gas;
wherein the plasma gas nozzle and the annular electrode are configured to form the plasma gas jet, and wherein the shielding nozzle is coaxial to the plasma gas nozzle.

20. The device of claim 15, wherein the electrode of the electric arc apparatus is disposed adjacent to or within a plasma gas nozzle and the plasma gas nozzle is disposed within a shielding nozzle.

21. The device of claim 11, wherein the machining device is configured to direct the laser beam toward the plasma gas jet from outside the plasma gas jet, wherein the laser beam and the plasma gas jet intersect at the machined spot and form an acute angle of less than 15°.
